(19) United States
(12) Patent Application Publication
(10) Pub. No.: US 2009/0122998 A1
(43) Pub. Date: May 14, 2009

(54) VENTED LOUDSPEAKER BOX SYSTEM AND ITS CONTROL METHOD

(75) Inventors: Gerrit Frederik Magdalena POORTERE, BORGERHOUT (BE); Stefan Margheurite Jean WILLEMS, ROOSDALLS (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,046

(22) PCT Filed: Oct. 13, 2005
(86) PCT No.: PCT/IB05/53362

§ 371 Date: Apr. 11, 2007

(30) Foreign Application Priority Data
Oct. 19, 2004 (CN) 200410083766.7

(51) Int. Cl. H04R 1/28

(52) U.S. Cl. 381/59

(57) ABSTRACT

A vented loudspeaker box system comprises a vented loudspeaker box, a music content analyzing device and a bass controlling device. The vented loudspeaker box is used for playing a music signal, the music content analyzing device is used for detecting the bass contents of the music signal, and the bass controlling device is used for adjusting the bass boost frequency of the vented loudspeaker box according to the detected result. The bass boost frequency is adjusted by adjusting the length of the bass port. With the invention, the bass components at the special dominant bass frequency can be enhanced appropriately during playing the music signal through the vented loudspeaker box, and the length of bass port is matched with the dominant bass frequency of the bass components adaptively and continuously, thereby improving the bass performance of the vented loudspeaker box system remarkably.

### FIELD OF THE INVENTION

The invention relates to a loudspeaker box and its control method, and more specifically to a vented loudspeaker box system and a control method of the vented loudspeaker box.

### BACKGROUND OF THE INVENTION

Generally, loudspeaker boxes can be classified as a closed loudspeaker box and a vented loudspeaker box based on box design.

In the closed loudspeaker box, a loudspeaker is installed on a closed box, i.e. the sound inside the box is completely isolated with the sound outside as if users hear sound at one side of a baffleplate that is large enough.

For the closed loudspeaker box, the sound waves inside the box are useless. However, in order to eliminate the interferences applied by the useless sound waves (stationary waves) to the vibration of the loudspeaker, high efficiency sound damping materials, such as porous cotton and the like, can be usually placed in the box. The damping materials can not only absorb the sound waves, but also reduce the propagating speed of the sound in the air. Using the damping materials is equivalent to enlarging the size of the box and to decreasing the impedance peak value at the resonance frequency. In addition, the air in the box can stay in an isothermal compression status, thereby increasing the virtual volume of the box.

The advantages of the closed loudspeaker box lie in it's pithiness at low frequency, quick response and clear at low frequency. It is excellent for classical and chamber music, but the bass performance is not good enough.

There are many kinds of the vented loudspeaker boxes, such as a maze style, an acoustic impedance style, a loudspeaker style and so on. They all have the features that bass ports (vented holes) are provided in the boards of the loudspeaker boxes.

The vented loudspeaker box operates under the principle of the Helmholtz resonator. The difference between the vented loudspeaker box and the closed loudspeaker box lies in that a cylindrical bass port is provided in the board of the box so as to allow the air exchange between the inside and outside of the box. If the size and position of the bass port are designed appropriately, the sound waves from the back of the loudspeakers can pass the bass port to have the phases of the sound waves inverted at some frequency band and added with those from the front of the loudspeaker. Then, the two sound waves radiate in same phase. In other words, the vented loudspeaker box utilizes the vibrations of the air in the box and of the air in the bass port together with the reflex function of the back board of the loudspeaker box to 180°-invert the sound waves from the back of the loudspeaker and to transmit the inverted sound waves through the bass port. In this case, the transmitted sound waves have the same phase as that of the sound waves generated directly from the loudspeaker, and thus the radiating energy at low frequency is enhanced.

Compared with the closed loudspeaker box, the vented loudspeaker box further extends the lower limit of the low frequency, for example, a loudspeaker that is installed in a suitable vented loudspeaker box will have a low frequency sound pressure that is 3 dB higher than that obtained when the same loudspeaker is installed in a closed loudspeaker box with the same volume, and thus this is good for the performance of the low frequency.

The bass performance of the vented loudspeaker box system depends on its acoustic tuning and electronic bass assisting tuning. In a conventional vented loudspeaker box system, the acoustic tuning of the loudspeaker is fixed and the electronic boost bass is tuned to a fixed frequency, due to loudspeaker excursion reasons. If the dominant bass frequency of the music signal does not correspond to the bass boost frequency of the loudspeaker box, the bass performance is not optimal. Ideally, the central frequency of the bass boost should correspond to the bass contents in the music.

Generally, the bass boost frequency of the loudspeaker box is tuned to the anti-resonance frequency of the vented loudspeaker box. The reason is that at the anti-resonance frequency, the cone excursion of the woofer is at its minimum and hence the bass boost can be at its maximum.

But, when the bass boost frequency of the loudspeaker box is adjusted to, for example, 55 Hz (which is a Low A or La), and the dominant bass frequency of the music signal is higher, the bass boost loses its function partly or totally. When the dominant bass frequency of the music signal is a low F or Fa, it is better to adjust the bass boost frequency of the loudspeaker box to 86.9135 Hz. Similarly, when the dominant bass frequency of the music signal is further higher, the bass boost frequency of the loudspeaker box also should be tuned to 86.9135 Hz.

The above described tuning can be implemented by changing the length of the bass port.

Generally, the filtering circuit for audio frequency filtering in the vented loudspeaker box is fixed, that means that the corresponding dominant bass frequency of the filtered music signal is not adjustable. As there are various kinds of music that are played by the vented loudspeaker box, if the dominant bass frequency is not adjustable, the bass boost performance of the vented loudspeaker box cannot be satisfactory.

In Japanese Patent Application No. 06-326416 filed on Dec. 27, 1994, a sound control device is disclosed. As shown in FIG. 1, the sound control device comprises a sound switch 2, a sound control unit 3, a bass port length control unit 4, and a loudspeaker unit 14.

The sound switch 2 is constituted by, for example, a slip sheet switch, for selecting the sound modes A, B, C, and D corresponding to the programs and providing selecting signals A1, B1, C1, and D1 to the sound control unit 3 and the bass port length control unit 4.

The bass port length control unit 4 calculates the target location signal corresponding to the selecting signals A1, B1, C1, and D1 of the sound switch and the difference signal. from the actual location signal SPI of the bass port cover from the sensors, and according to the difference signal, generates a motor driving signal VM, and provides it to a motor 18 for adjusting the location of the bass port cover, so as to adjust the length of the bass port.

It can be seen that, the target location of the bass port cover is set manually through the sound switch according to the types of music. However, in fact, not only different pieces of music (music compositions or songs etc.) have different dominant bass frequencies, but also the dominant bass frequency of one piece-of music may fluctuate. In the case of the dominant bass frequency of a piece of music being dynamic and continually changing, it is difficult for the above prior art to adjust the dominant bass frequency and the location of the bass port cover continually according to the subject of the music. Therefore, this static control method can not solve the technical difficulty that the bass boost frequency of a vented loudspeaker box cannot adaptively match with the dominant bass frequency of the played music.

For the above reasons, there is a need to provide a vented loudspeaker box system capable of controlling dynamically the bass port length of the vented loudspeaker box and changing the dominant bass frequency of the filtered music according to the played music to enhance selectively the bass components at the dominant bass frequency of the music during the process where the music is played out through the operation of the vented loudspeaker, and to enable the length of the bass port to match adaptively and continually with the dominant bass frequency of every piece of music.

### OBJECT AND SUMMARY OF THE INVENTION

It is therefore an object of the present invention to provide a vented loudspeaker box system capable of monitoring continuously the bass content of a played music signal and adjusting dynamically the bass boost frequency of the vented loudspeaker box by changing the acoustic length of the bass port of the vented loudspeaker box.

It is another object of the invention to provide a vented loudspeaker box system capable of enhancing selectively the bass components at the corresponding dominant bass frequency of a played music signal according to the bass content of the played music signal.

It is a further object of the invention to provide a vented loudspeaker box system capable of, according to the bass content of a received music signal, adjusting dynamically the bass boost frequency of the vented loudspeaker box by changing the acoustic length of the bass port of the vented loudspeaker box, and enhancing selectively the bass components at the corresponding dominant bass frequency of a played music signal.

It is further another object of the invention to provide a control method for a vented loudspeaker box capable of, according to the bass content of a received music signal, adjusting dynamically the bass boost frequency of the vented loudspeaker box by changing the acoustic length of the bass port of the vented loudspeaker box, and enhancing selectively the bass components at the corresponding dominant bass frequency of a played music signal.

To this end, there provides a vented loudspeaker box system according to the invention, comprising a vented loudspeaker box for playing a music signal, a music content analyzing device for detecting the bass contents of the music signal, and a bass controlling device for adjusting the bass boost frequency of the vented loudspeaker box according to the compared result signal output from the music content analyzing device.

According to an aspect of the invention, the vented loudspeaker box includes at least a loudspeaker and a bass port having an adjustable length for adjusting the bass boost frequency of the loudspeaker box.

The music content analyzing device includes: a plurality of filtering devices with different frequency ranges, for filtering respectively the received music signals and outputting correspondingly a plurality of filtered signals within different bass frequency bands; a plurality of level detecting devices, the number of which corresponds to that of the filtering devices, for detecting respectively the corresponding filtered signals output from the filtering devices and outputting correspondingly a plurality of signal levels; and a comparing device for comparing the signal levels and outputting a compared result signal representing the maximum signal level of them.

According to another aspect of the invention, the vented loudspeaker box further includes a bass enhancement device for enhancing selectively the bass components at the corresponding dominant bass frequency of a played music signal according to the compared result signal.

The bass enhancement device includes: a plurality of filtering devices with different frequency ranges; an amplifying devices; and a switching device for connecting selectively one of the filtering devices with the amplifying devices according to the compared result signal, so as to transfer the bass component signal having corresponding dominant bass frequency output from the filtering device to the amplifying device and then, after being amplified by the amplifying device, to the vented loudspeaker box.

According to the invention, further provided is a vented loudspeaker box system comprising a vented loudspeaker box for playing a music signal, a music content analyzing device for analyzing the bass contents of the music signal, and a bass enhancement device for enhancing selectively the bass components at the corresponding dominant bass frequency of the music signal according to the compared result signal output from the music content analyzing device.

According to the invention, further provided is a control method for a vented loudspeaker box for playing a music signal, which control method comprises the following steps: detecting the bass contents of the music signal; and adjusting the bass boost frequency of the vented loudspeaker box according to the detected result.

Furthermore, according to the invention, further provided is a control method for a vented loudspeaker box for playing a music signal, which control method comprises the following steps: detecting the bass contents of the music signal; and enhancing selectively the bass components at the corresponding dominant bass frequency of the music signal according to the detected result.

With the vented loudspeaker box system or the control method for a vented loudspeaker box according to the invention, the bass components at the corresponding dominant bass frequency of a music signal can be enhanced selectively when the music signal is played with a vented loudspeaker box, and the length of the bass port of the vented loudspeaker box is matched adaptively and continuously with the dominant bass frequency, thus improving remarkably the bass effects of the vented loudspeaker box system.

These and other objects, features and advantages of the present invention will become apparent from the following detailed description with reference to the accompanying drawings.

### BRIEF DESCRIPTION OF THE DRAWINGS

FIG. 1 shows schematically a block diagram of a sound control device of the prior art;

FIG. 2 is a schematic diagram of a vented loudspeaker box system according to a first embodiment of the present invention;

FIG. 3 is a frequency response diagram of a third filtering device in the vented loudspeaker box system according to the first embodiment of the present invention;

FIG. 4 is a frequency response diagram of the fourth filtering device in the vented loudspeaker box system according to the first embodiment of the present invention;

FIG. 5 is a schematic diagram of a vented loudspeaker box system according to a second embodiment of the present invention;

FIG. 6 is a schematic diagram of a vented loudspeaker box system according to a third embodiment of the present invention; and

FIG. 7 is a flow diagram of a control method for a vented loudspeaker box, according to a fourth embodiment of the present invention.

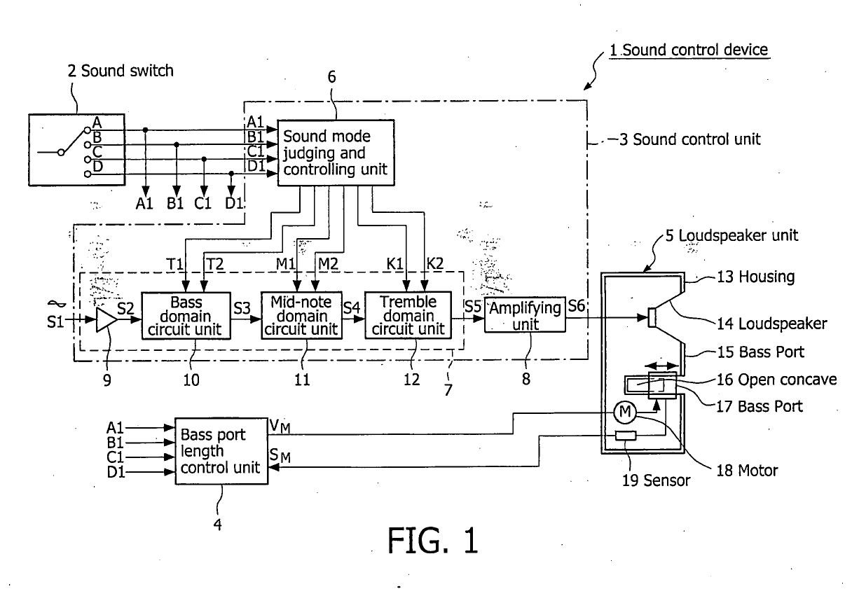

### DETAILED DESCRIPTION OF THE INVENTION

Hereinafter, the embodiments of the invention will be described in detail with reference to the drawings.

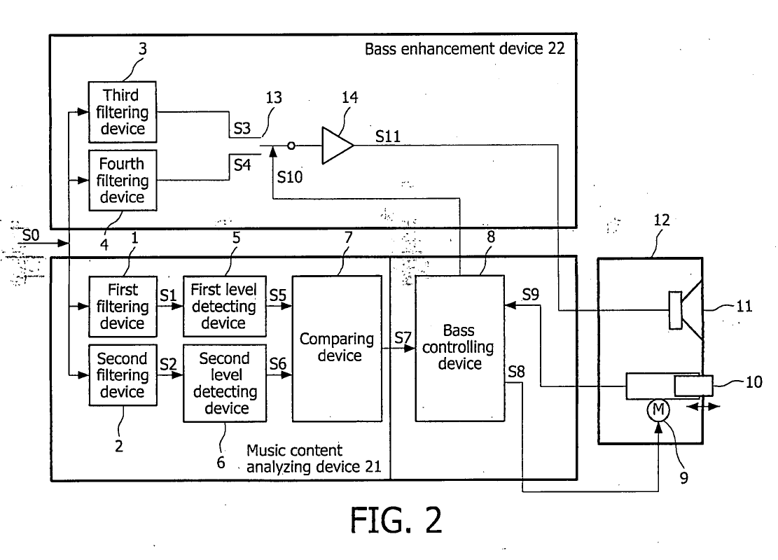

FIG. 2 is a schematic diagram of a vented loudspeaker box system according to a first embodiment of the present invention. As shown in FIG. 2, the vented loudspeaker box system according to the present invention includes a vented loudspeaker box 12. The vented loudspeaker box 12 includes at least a loudspeaker 11, and a bass port 10, the length of which can be adjusted. The loudspeaker 11 is to reproduce the bass components at a preferred low frequency of a music signal, and the bass boost frequency of the vented loudspeaker box 12 can be adjusted by adjusting the length of the bass port 10. The length of the bass port 10 can be adjusted by a motor 9.

The bass port 10 has two tuning positions: a lowest frequency tuning position for a bass frequency fL (55 Hz-La), and a highest tuning position for a tremble frequency fH (86.9135 Hz-Fa). These frequencies are the frequencies of the notes tuned according to the well-tempered West Atlantic for achieving optimal effect.

The vented loudspeaker box system according to the present invention further includes a music content analyzing device 21 for analyzing the bass contents of the music signal.

The music content analyzing device 21 comprises a first filtering device 1, a second filtering device 2 having different frequency range from that of the first filtering device 1, a first level detecting device 5, a second level detecting device 6, and a comparing device 7. The first filtering device 1 is a fourth order Butterworth low pass filter with f_{-3 db}=60 Hz; the second filtering device 2 is a fourth order Butterworth band pass filter (each slope 2nd order) with f_{-3 db}=70 Hz and 90 Hz.

The vented loudspeaker box system according to the present invention further includes a bass controlling device 8 for adjusting the bass boost frequency of the vented loudspeaker box 12 according to the compared result signal output from the music content analyzing device 21.

The vented loudspeaker box system further includes a bass enhancement device 22 for amplifying the bass components at special dominant frequency of the played music signal and transferring them to the loudspeaker 11 according to the compared result signal output from the music content analyzing device 21.

The bass enhancement device 22 comprises a third filtering device 3, a fourth filtering device 4 having different frequency range from that of the first filtering device 3, a switching device 13 and an amplifying devices 14. The third filtering device 3 and the fourth filtering device 4 are selectively connected to the amplifying devices 14 through the switching device 13, and the amplifying devices 14 is connected to the loudspeaker 11.

In the first embodiment according to the invention, the third filtering device 3 is a bass enhancement filtering device for producing a bass component signal at a frequency of 55 Hz, and the fourth filtering device 4 is a bass enhancement filtering device for producing a bass component signal at a frequency of 86.9135 Hz. Of course, the third filtering device 3 and the fourth filtering device 4 which have different parameters are selected according to requirements, so that the frequencies of the generated bass component signals can be changed correspondingly.

As shown in FIG. 2, the first filtering device 1 and the second filtering device 2 receive respectively the music signal S0 from a music source (not shown), and filter the music signal S0 to produce a first filtered signal S1 and a second filtered signal S2 respectively. The first level detecting device 5 and the second level detecting device 6 detect the actual signal levels of the first filtered signal S1 and the second filtered signal S2, respectively, and output a first signal level S5 and a second signal level S6.

Since the first filtering device 1 is a low pass filter with f−3 db=60 Hz, and the second filtering device 2 is a band pass filter with f−3 db=70 Hz and 90 Hz, the first signal level S5 and the second signal level S6 represent energy of the signals whose frequency is lower than 60 Hz (low pass) and whose frequency is between 70 Hz and 90 Hz (high band), in the music signal S0, respectively.

In the first preferred embodiment of the invention, the relationship between the first filtered signal S1 and the first signal level S5 can be represented in the digital domain as follows:

S5[n]=|S1[n]|+Kp·(S5[n−1]−|S1[n]|)+Km·|S5[n−1]−|S1[n]||

Similarly, the relationship between the second filtered signal S2 and the second signal level S6 can be represented as:

S6[n]=|S2[n]|+Kp·(S6[n−1]−|S2[n]|)+Km·|S6[n−1]−|S2[n]||

### Where

Ka=e^{-1/(τ}^{ₐ}^{·ƒs)}

Kr=e^{-1/(τ}^{ᵣ}^{·ƒs)}

Kp=(Kr+Ka)/2

Km=(Kr−Ka)/2

In the present embodiment, the parameters have the following values:

τₐ=0.1 s

τᵣ=2.0 s

ƒs=44.1 kHz

where τₐand τᵣ are also called “attack time constant” and “release time constant”.

The comparing device 7 compares the first signal level S5 and the second signal level S6. According to the compared result, a compared result signal S7 is output for controlling the length adjustment of the bass port 10 and/or the selection of the switching device 13. In addition, the comparing device 7 has two functions: 1) to guarantee a stable output of the compared result signal S7 by building hysteresis function, 2) to prevent triggering on noise. The compared result signal S7 is a two bits signal including the first bit S7[1] and the second bit S7[2].

To create the hysteresis function, a factor “Cross-Threshold” is defined.

Usually, if S5>S6×Cross-Threshold, in other words, when S5/S6>Cross-Threshold, the first signal level S5 is considered to be bigger than the second signal level S6, and vice versa.

This condition can prevent the ‘nervous’ reaction of the comparing device 7 when the two signals are almost equal and are continuously overtaking each other. In this embodiment, Cross-Threshold=1.2.

The following Table 1 describes the relationship among the first signal level S5, the second signal level S6 and the compared result signal S7.

TABLE 1

| S5 × Cross- | S6 × Cross- | | |
|---|---|---|---|
| Threshold | Threshold | S7[1] | S7[2] |
| >S6 | <S5 | 1 | 0 |
| <S6 | >S5 | 0 | 1 |
| >S6 | >S5 | 1 | 1 |
| <S6 | <S5 | not possible | not possible |

The comparing device 7 is used to check which of the first signal level S5 or the second signal level S6 is the most important one, i.e., has a higher value. Since the first signal level S5 and the second signal level S6 come from the first level detecting device 5 and the second level detecting device 6 respectively, they represent the energy of the signals in the bands determined by the first filtering device 1 and the second filtering device 2.

The comparing device 7 must also deal with situations when there is no signal present, e.g. during pause or track change. In that case only noise is present and the danger exists that the comparing device 7 reacts on these meaningless noise signals. In order to avoid the system from reacting to noises, a factor Noise-Threshold is introduced. If both signals from the first filtering device 1 and the second filtering device 2 are equal to or less than a set threshold, the signals are judged to be noises. In this case, both S7[1] and S7[2] of the compared result signal S7 of the comparing device 7 are forced to be set to 1 (as shown in Table 2), so as to keep the bass port 10 at its actual position.

TABLE 2

| S5 > Noise-Threshold | S6 > Noise-Threshold | S7[1] | S7[2] |
|---|---|---|---|
| 0 | 0 | 1 | 1 |

| | |
|---|---|
| other | Table 1 applies |

The compared result signal S7 and a bass port position signal S9 which comes from the bass port 10 and represents the tuning position of the bass port 10 are inputted to the bass controlling device 8.

The bass port position signal S9 is also a two bits signal, including a first bit S9[1] and a second bit S9[2].

The following table 3 describes the relationship between the fist bit S9[1] and the second bit S9[2] of the bass port position signal S9, and the tuning status of the bass port 10.

TABLE 3

| S9[1] | S9[2] | Bass port |
|---|---|---|
| 0 | 0 | f_{H} |
| 0 | 1 | Moving |
| 1 | 0 | Not Valid |
| 1 | 1 | fL |

The bass controlling device 8 outputs a motor control signal S8 to the motor 9 for adjusting the tuning position of the bass port 10, according to the comparing result signal S7 and the bass port position signal S9, and outputs a switch control signal S10 to the switching device 13.

The motor control signal S8 is also a two bits signal, including the first bit S8[1] and the second bitS8[2].

The following table 4 describes the relationship between the fist bit S8[1] and the second bit S8[2] of the motor control signal S8, and the operating status of the bass port 10 adjusted by the motor 9.

TABLE 4

| S8[1] | S8[2] | Action |
|---|---|---|
| 0 | 0 | Bassport STOPPED at f_{H} |
| 0 | 1 | Bassport STOPPED at f_{L} |
| 1 | 0 | Bassport MOVING at f_{H} |
| 1 | 1 | Bassport MOVING at f_{L} |

Further referring to FIG. 2, the bass controlling device 8 outputs a switch control signal S10 to the switching device 13 based on the bass contents of the music signal S0, and the third filtering device 3 or the fourth filtering device 4 is selected to connect to the input end of the amplifying devices 14.

In other words, when the first signal level S5 is bigger than the second signal level S6, the bass controlling device 8 produces the switch control signal S10 to connect the third filtering device 3 to the amplifying devices 14. The third filtering device 3 receives the music signal S0 from the music source to filter the music signal S0 to produce the third filtered signal S3, and correspondingly sets the dominant bass frequency of the music signal to 55 Hz.

When the first signal level S5 is smaller than the second signal level S6, the bass controlling device 8 produces the switch control signal S10 to connect the fourth filtering device 4 to the amplifying devices 14. The fourth filtering device 4 receives the music signal S0 from the music source to filter the music signal S0 to produce the fourth filtered signal S4, and correspondingly sets the dominant bass frequency of the music signal to 86.9135 Hz.

In this embodiment, when the switch control signal S10=1, the amplifying devices 14 connects to the third filtering device 3, and the third filtered signal S3 is delivered to the amplifying devices 14. When the switch control signal S10=0, the amplifying devices 14 connects to the fourth filtering device 4, and the fourth filtered signal S4 is delivered to the amplifying devices 14.

The third filtered signal S3 and the fourth filtered signal S4 are bass component signals, and after being amplified by the amplifying device 14, are provided to the loudspeaker 11 to produce bass boost effects at anticipated frequency.

The following table 5 describes the relationships between the compared result signal S7 and the bass port position signal S9, and the motor control signal S8 and the switch control signal S10.

TABLE 5

| Current situation | | | | | New situation | | |
|---|---|---|---|---|---|---|---|
| S7[1] | S7[2] | S9[1] | S9[2] | S8[2] | S8[1] | S8[2] | Action |
| 1 | 1 | 0 | 0 | 0 | 0 | 0 | Remain at f_{H} |
| 1 | 1 | 0 | 0 | 1 | 1 | 1 | Move to f_{L} |
| 1 | 1 | 0 | 1 | 0 | 1 | 0 | Move to f_{H} |
| 1 | 1 | 0 | 1 | 1 | 1 | 1 | Move to f_{L} |
| 1 | 1 | 1 | 0 | 0 | 0 | 0 | Not relevant |
| 1 | 1 | 1 | 0 | 1 | 0 | 1 | Not relevant |
| 1 | 1 | 1 | 1 | 0 | 1 | 0 | Move to f_{H} |
| 1 | 1 | 1 | 1 | 1 | 0 | 1 | Remain at f_{L} |
| 0 | 1 | 0 | 0 | 0 | 0 | 0 | Remain at f_{H} |
| 0 | 1 | 0 | 0 | 1 | 1 | 1 | Move to f_{L} |
| 0 | 1 | 0 | 1 | 0 | 1 | 0 | Move to f_{H} |
| 0 | 1 | 0 | 1 | 1 | 1 | 1 | Move to f_{L} |
| 0 | 1 | 1 | 0 | 0 | 0 | 0 | Not relevant |
| 0 | 1 | 1 | 0 | 1 | 0 | 1 | Not relevant |
| 0 | 1 | 1 | 1 | 0 | 1 | 0 | Move to f_{H} |
| 0 | 1 | 1 | 1 | 1 | 1 | 0 | Move to f_{H} |
| 1 | 0 | 0 | 0 | 0 | 1 | 1 | Move to f_{L} |
| 1 | 0 | 0 | 0 | 1 | 1 | 1 | Move to f_{L} |
| 1 | 0 | 0 | 1 | 0 | 1 | 0 | Move to f_{H} |
| 1 | 0 | 0 | 1 | 1 | 1 | 1 | Move to f_{L} |
| 1 | 0 | 1 | 0 | 0 | 0 | 0 | Not relevant |
| 1 | 0 | 1 | 0 | 1 | 0 | 1 | Not relevant |
| 1 | 0 | 1 | 1 | 0 | 1 | 0 | Move to f_{H} |
| 1 | 0 | 1 | 1 | 1 | 0 | 1 | Move to f_{L} |

Where S10 = S8[2].

The bass controlling device 8 determines finally a preferred position of the bass port 10 and the switching position of the switching device 13. Also, the bass port position signal S9 indicating the actual location of the bass port 10 is fed back to the bass controlling device 8. The bass port position signal S9 is a two bits signal including a first bit S9 [1] and a second bit S9[2], and determined by two switches mounted on the bass port.

When closed, the switch represents a logic “1”. When opened, the switch represents a logic “0”. In case the first bit S9[1] and the second bit S9[2] of the bass port position signal S9 both are 0, the bass port is in its longest position corresponding to fH. When the two switches are closed, both the first bit S9[1] and the second bit S9[2] are 1, and the bass port is in its shortest position corresponding to fL. This configuration is only one embodiment. Alternatively, the length of the bass port can be adjusted in other manners.

When S9[1]=0 and S9[2]=1, the bass port is moving. Since the bass controlling device 8 receives the bass port position signal S9 representing current position of the bass port position with the first bit S9[1] and the second bit S9[2] encoded in the above manner, it can output the motor control signal S8 indicating whether the tuning position of the bass port is adjusted.

The Table 5 is built up according to the following hierarchical rules:

1) When the bass port is moving to either direction, make sure to keep it moving until it reached its target position (sensing via the bass port position signal S9), even in the meantime the compared result signal S7 changes. Otherwise, the bass port could make nervous movements, which are probably not desired by the user and which are probably accompanied with motor noise.

2) Take into account of the slow responses of the motor 9 and the switching device 13. When the motor 9 starts to rotate, the switching device 13 will not change its status immediately.

An example is set forth below:

1) S7[1]=S7[2]=1→Noisy

2) S9[1]=S9[2]=0→Bass port currently at f_{H} position

3) S8[2]=1→bass port stopped or moving to f_{L} position

From conditions 2) and 3) it is decided that the bass port 10 starts to move towards fL position, but the switching device 13 haven't reacted yet.

Although condition 1) tells that right now, a noise is only detected, it still can make sure to keep the bass port 10 moving.

By controlling the operation of the switching device 13 and adjusting the length of the bass port (thus the bass boost frequency of the vented loudspeaker box), the bass boost frequency of the vented loudspeaker box is adaptively adjusted to a frequency at which most of the bass content can be heard by the listeners. The listeners thus experience an optimal bass performance.

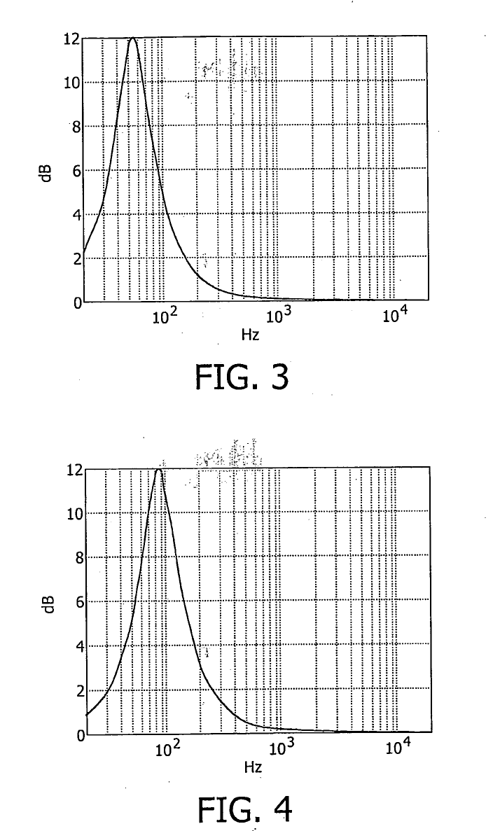

FIG. 3 is a frequency response curve of the third filtering device 3 in the vented loudspeaker box system according to the first embodiment of the present invention. FIG. 4 is a frequency response curve of the fourth filtering device 4 in the vented loudspeaker box system according to the first embodiment of the present invention.

As shown in FIG. 3 and FIG. 4, the peak values of the frequency response curves of the third filtering device and the fourth filtering device occur at Helmholtz frequency of the vented loudspeaker box. When the frequency is lower than Helmholtz frequency, the amplitude of the loudspeaker increases sharply, and at same time the sensitivity is reduced. This will cause distortion. Therefore, when the frequency is lower than Helmholtz frequency, the gains of the third filtering device and the fourth filtering device are reduced. In order to better suppress the signal at the frequency lower than Helmholtz frequency, high pass filtering devices may be additionally provided which are connected in series with the third filtering device and the fourth filtering device respectively.

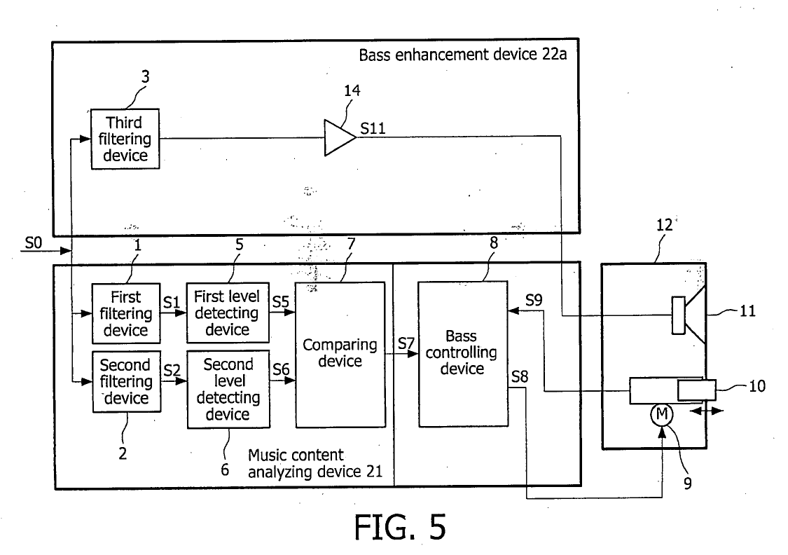

FIG. 5 is a schematic diagram of a vented loudspeaker box system according to a second embodiment of the present invention.

In the second embodiment, same reference numbers indicate the same parts as in the first embodiment. For simplification, the description of these parts is omitted.

The vented loudspeaker box system of the second embodiment is different from that of the first embodiment in that, a bass enhancement device 22a only comprises a third filtering device 3 and an amplifying devices 14 so that the bass component at the special dominant bass frequency of the music signal can not be selectively enhanced according to the detected result of the music content analyzing device 21. The third filtering device 3 is used to filter the music signal, so as to produce a bass component signal at the dominant bass frequency. The dominant bass frequency is defined by the third filtering device 3. The amplifying devices 14 is connected with the third filtering device 3, and is used to amplify the bass component signal and to transfer the amplified bass component signal to the loudspeaker 11.

The parameters of the third filtering device are selected, so that the dominant bass frequency of the bass component generated by the third filtering device is a desired fixed value. Also, the parameters of the third filtering device are selected according to requirements, so that a bass component can be generated whose dominant bass frequency can be adjusted in a step manner.

In the case that the dominant bass frequency of the bass component generated by the third filtering device is a fixed value, the dominant bass frequency of the music signal received by the loudspeaker 11 can not be changed, and the length of the bass port of the vented loudspeaker box is adjusted only according to the bass contents of the music signal. The adjustment manner of the length of the bass port of the vented loudspeaker box is the same as that in first embodiment, and is not repeatedly described.

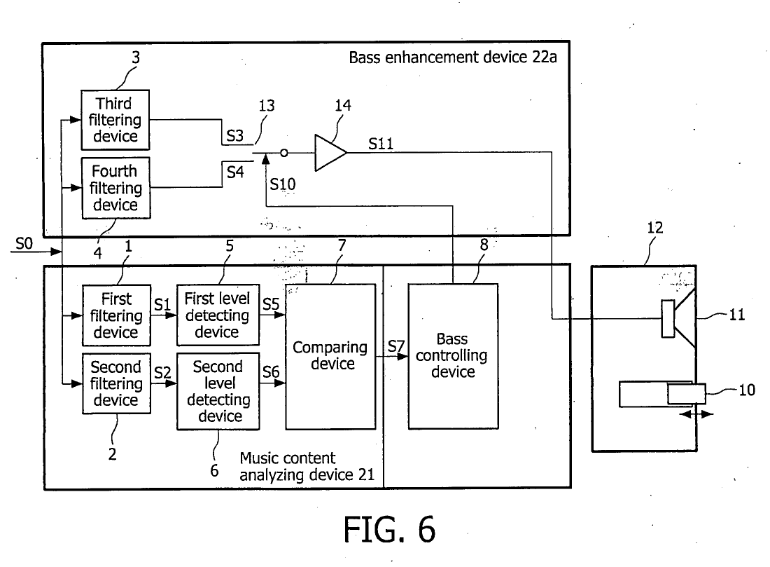

FIG. 6 shows a block diagram of a vented loudspeaker box system according to a third embodiment of the present invention.

In the third embodiment, same reference numbers indicate the same parts as in the first embodiment. For simplification, the description of these parts is omitted.

The vented loudspeaker box system of the third embodiment is different from that of the first embodiment in that, the bass controlling device 8 enhances selectively the bass component at the corresponding dominant bass frequency of the played music signal only according to the compared result signal S7 output by the music content analyzing device 21, but does not adjust the length of the bass port 10 of the vented loudspeaker box 12, and furthermore it is not needed to monitor the actual tuning position of the bass port.

Of course, for simplification, the present vented loudspeaker box system may not have the bass controlling device 8, and at this time, such system can controls the switching device 13 directly according to the compared result signal S7, so that the bass component at the corresponding dominant bass frequency of the played music signal can be selectively enhanced.

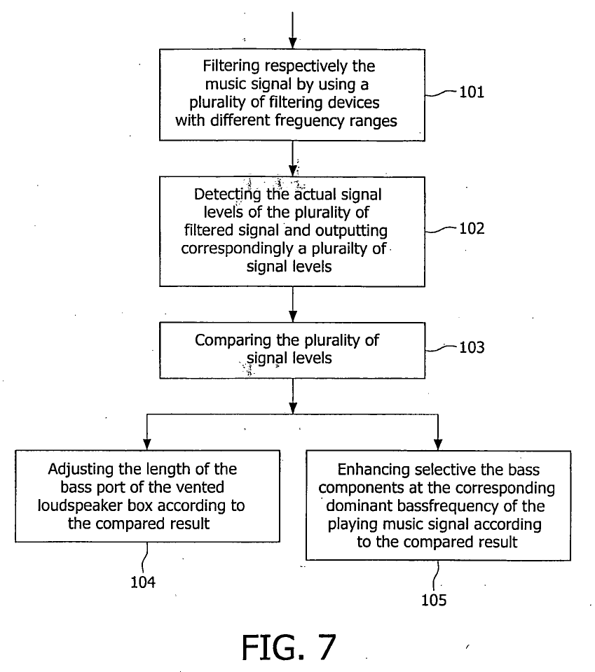

FIG. 7 is a flow diagram of a control method for a vented loudspeaker box, according to a fourth embodiment of the present invention.

According to the invention, the control method for a vented loudspeaker box comprises the following steps of:

detecting the bass contents of a music signal; and

adjusting correspondingly the bass boost frequency of the vented loudspeaker box according to the detected result.

According to the invention, the control method for a vented loudspeaker box further comprises a step of enhancing selectively the bass components at the corresponding dominant bass frequency of the played music signal according to the detected result.

Of course, the steps of adjusting the bass boost frequency of the vented loudspeaker box and enhancing selectively the bass components at the corresponding dominant bass frequency of the played music signal can be executed individually or simultaneously.

More specifically (see FIG. 7), the step of detecting the bass contents of the played music signal comprises:

filtering the music signal by using a plurality of filtering devices with different frequency ranges (Step S101);

detecting the actual signal levels of the filtered signals and outputting correspondingly a plurality of signal levels (Step S102); and

comparing the plurality of signal levels (Step S103).

The step of adjusting the bass boost frequency of the vented loudspeaker box includes a step of adjusting the length of the bass port of the vented loudspeaker box according to the compared result of the plurality of signal levels (Step S104).

And the step of enhancing selectively the bass components at the corresponding dominant bass frequency of the played music signal according to the detected result (Step S105) includes:

Controlling the operation of a switching device according to the compared result of the plurality of signal levels to connect one of the filtering devices with different frequency ranges between a music source and the loudspeaker via an amplifying device, so as to change the dominant bass frequency of the bass components of the music signal.

According to the invention, the music content analyzing device 21 continuously monitors and analyzes the bass content of the music signal to provide in real time a switch control signal S10 to the switching device 13, so that the third filtering device 3 or the fourth filtering device 4 is connected to the amplifying devices 14, to enhance correspondingly the bass components with different dominant bass frequencies. Additionally, when the motor 9 receives the motor control signal S8, the tuning position of the bass port 10 is adjusted so that the bass boost frequency of the vented loudspeaker box is adjusted to a frequency corresponding to the dominant bass frequency of the bass component. Therefore, the bass performance of the played music is improved.

Although the present invention has been described in terms of its presently preferred embodiments, the preferred embodiments are illustrative but not to be interpreted as limiting. After reading the above embodiments, those skilled in the art may make various modifications and alternations without departing from the spirit and scope of the invention.

For example, the above music content analyzing device 21 comprises two filtering devices and two level detecting devices, i.e. a first filtering device, a second filtering device, a first level detecting device and a second level detecting device. According to requirements, the music content analyzing device may comprises another filtering device with different frequency ranges from those of the first filtering device and the second filtering device, and another level detecting device, such as a fifth filtering device and a third level detecting device (not shown), which fifth filtering device similarly filter the played music signal and outputs a third filtered signal. The third level detecting the actual signal level to output a third signal level in this case, the comparing device compares the first signal level, the second signal level, and the third signal level, and outputs a compared result signal representing the maximum signal level among them.

Thus, the above music content analyzing device can compare the energies of the music signals at three frequency bands, and selects out the frequency band having the highest energy.

Similarly, the number of the filtering devices contained in the bass enhancement device 22 is not limited to one or two. The bass enhancement device 22 may also have a sixth filtering device (not shown) having different frequency range from those of the third and fourth filtering devices. In this case, according to the switch control signal from the bass controlling device, the switching device 13 selectively connects one of the third, fourth and sixth filtering devices to the amplifying device, so as to enhance the bass component at the corresponding dominant bass frequency of the played music signal.

The filtering device according to the invention may be an adjustable filtering device, i.e. the same adjustable filtering device can filter signals having different frequencies.

The vented loudspeaker box system according to the invention may further be applied to improve the speech articulation, especially in an environment that both speech and music are simultaneously presented. When no bass frequency is detected, the bass enhancement function is switched off to make the voice more clear. If the bandwidth for voice is limited to a frequency range from 300 Hz to 3 kHz, then there are no low frequency signals present, and hence it will not make any difference to switch bass boost on or off.

In addition, the present invention can also be applied to a mobile entertainment device, e.g. MP3 player, with headphones. The method for continuously measuring and analyzing the dominant bass frequency can be used to create a bass boost with a central frequency associated with the played music, thus obtaining an excellent bass performance. Since the in-ear headphones generally are provided with a bass port, the techniques disclosed in this invention may be used to tune the bass port by means of a micro-motor.

In the above-mentioned preferred embodiments, the bass port 10 has two discrete tuning positions. Of course, the bass port 10 may have discrete tuning positions more than two. Furthermore, the tuning of the bass port 10 can also be performed in continual or non-discrete manner. In this case, the bass controlling device 8 must continually monitor the position of the bass port 10. This scheme can be carried out by a potentiometer controlled by a motor.

It is also possible to employ the principle of a flute. For example, valves are used to open and close holes of the bass port to adjust the acoustic length of the bass port.

The invention can be applied in various vented loudspeaker systems, such as AV systems (subwoofer), mini and micro systems, multimedia loudspeakers and television sets.

Those skilled in the art should know that, some parts of the vented loudspeaker box system according to the invention may be implemented by means of software.

Although the present invention has been described with reference to the presently preferred embodiments, it is to be understood that the present invention is not limited to the disclosed embodiments. In contrary, the present invention intends to cover various alternations and equivalent configurations within the spirit and scope of the appended claims. The appended claims should be interpreted in broadest sense, so as to cover all alternations and equivalent structures and functions.

1. A vented loudspeaker box system, comprising:
a vented loudspeaker box for playing a music signal;
a music content analyzing means for detecting the bass contents of the music signal; and
a bass controlling means for adjusting the bass boost frequency of the vented loudspeaker box according to the detected result.

2. The system according to claim 1, wherein the music content analyzing means includes:
at least two filtering means for filtering respectively said music signal and outputting correspondingly a set of filtered signals having different bass frequencies;
at least two corresponding level detecting means for detecting respectively the corresponding signal levels of the set of filtered signals and outputting a set of corresponding signal levels; and
a comparing means for comparing the set of signal levels and outputting said detected result.

3. The system according to claim 2, wherein if the ratio of one signal level to another signal level in said set of signal levels is greater than a specified factor, said detected result output from said comparing means indicates that said one signal level is bigger than said another signal level.

4. The system according to claim 2, wherein if any of said set of signal levels is less than a threshold, said detected result output from said comparing means indicates that there is no signal input.

5. The system according to claim 1, wherein said vented loudspeaker box includes at least a loudspeaker and a bass port whose length is adjustable, and said bass controlling means adjusts the bass boost frequency of the loudspeaker box by adjusting the length of the bass port.

6. The system according to claim 5, wherein said bass port has at least two discrete tuning positions corresponding to different lengths of the bass port.

7. The system according to claim 5, wherein said vented loudspeaker box further includes a motor for adjusting the length of said bass port.

8. The system according to claim 1, further including a bass enhancement means for enhancing the bass components at the specified dominant bass frequency of said music signal.

9. The system according to claim 1, further including a bass enhancement means for enhancing selectively the bass components at the corresponding dominant bass frequency of said music signal according to said detected result.

10. A vented loudspeaker box system, comprising:
a vented loudspeaker box for playing a music signal;
a music content analyzing means for detecting the bass contents of the music signal; and
a bass enhancement means for enhancing selectively the bass components at the corresponding dominant bass frequency of said music signal according to the detected result.

11. The system according to claim 10, wherein said bass enhancement means includes:
at least two filtering means with different frequency ranges, an amplifying means, and a switching means,
wherein said switching means is used to connect selectively one filtering means of said at least two filtering means to the amplifying means according to said detected result, so that the bass component signal having corresponding dominant bass frequency output from said one filtering means is delivered to the amplifying means and then, after being amplified by the amplifying means, delivered to said vented loudspeaker box.

12. A control method for a vented loudspeaker box for playing a music signal, said control method comprising the steps of:
detecting bass contents of the music signal; and
adjusting continuously the bass boost frequency of the vented loudspeaker box according to the detected result.

13. The control method according to claim 12, further comprising the step of:
enhancing selectively the bass components at the corresponding dominant bass frequency of said music signal according to said detected result.

14. A control method for a vented loudspeaker box for playing a music signal, said control method comprising the steps of:
detecting bass content of the music signal; and
enhancing selectively bass components at the corresponding dominant bass frequency of the music signal according to the detected result.

15. The control method according to claim 12, wherein the detecting step comprises steps of:
filtering said music signal, so as to obtain a set of at least two filtered signals having different bass frequencies;
detecting the corresponding actual signal levels of the set of filtered signals, so as to obtain a set of corresponding signal levels; and
comparing the set of signal levels to output said detected result.
